(19) United States
(12) Patent Application Publication
(10) Pub. No.: US 2024/0173581 A1
(43) Pub. Date: May 30, 2024

(54) SYSTEM AND METHOD FOR EXTINGUISHING FIRE IN HIGH VOLTAGE BATTERY FOR VEHICLE

(71) Applicants: Hyundai Motor Company, Seoul (KR); Kia Corporation, Seoul (KR)

(72) Inventor: Young-Bin JEONG, Suwon-Si (KR)

(73) Assignees: Hyundai Motor Company, Seoul (KR); Kia Corporation, Seoul (KR)

(21) Appl. No.: 18/242,952

(22) Filed: Sep. 6, 2023

(30) Foreign Application Priority Data
Nov. 25, 2022 (KR) 10-2022-0160748

(51) Int. Cl. A62C 3/07; A62C 37/40; B60L 50/60; H01M 10/625

(52) U.S. Cl. CPC A62C 3/07; A62C 37/40; B60L 50/66; H01M 10/625

(57) ABSTRACT

A system and a method for extinguishing a fire in a high voltage battery for a vehicle, which supply cooling water flowing in an upper portion of a high voltage battery to the high voltage battery when a fire occurs in the high voltage battery, extinguishing the fire, include a battery cell assembly, an upper cooling passage which is provided in an upper portion of the battery cell assembly and through which cooling water flows, an upper plate including at least one through-hole and disposed between the battery cell assembly and the upper cooling passage to separate the battery cell assembly and the upper cooling passage, and solderings disposed in the at least one through-hole in the upper plate at intervals and configured to be melted at a predetermined temperature. When a temperature of the battery cell assembly due to the fire is predetermined temperature or higher, the solderings are melted and the cooling water is supplied to the battery cell assembly.

### CROSS-REFERENCE TO RELATED APPLICATION

The present application claims priority to Korean Patent Application No. 10-2022-0160748, filed on Nov. 25, 2022, the entire contents of which is incorporated herein for all purposes by this reference.

### BACKGROUND OF PRESENT DISCLOSURE

### Field of Present Disclosure

The present disclosure relates to a system and a method for extinguishing a fire in a high voltage battery for a vehicle, which supply cooling water flowing in an upper portion of a high voltage battery to the high voltage battery when a fire occurs in the high voltage battery provided in a vehicle, extinguishing the fire in the high voltage battery.

### Description of Related Art

Recently, due to the electrification of vehicles, the supply of eco-friendly vehicles provided with high voltage batteries, such as electric vehicles, is rapidly expanding.

The high voltage battery is charged with electrical energy at a high density and is packed in a form of a battery pack by stacking cells in which an anode, a cathode, an electrolyte, and separators are provided. Therefore, when a fire occurs in the high voltage battery, there is a problem in that it is not easy to extinguish the fire.

According to an aspect of the fire in the high voltage battery, when a fire occurs in any one cell, the fire rapidly spreads to other adjacent cells and proceeds until the high voltage battery is entirely burnt out.

Generally, a method of extinguishing a fire in a high voltage battery is to spray water until the fire is extinguished. However, because cells are stacked inside a high voltage battery case, water sprayed from the outside thereof does not easily reach the inside of the high voltage battery case, and thus it is difficult to actually extinguish the fire. Accordingly, the fire in the high voltage battery may proceed for several tens of hours.

To solve the above problem, a prefabricated water tank is provided around a vehicle, and the water tank is filled with water to submerge the high voltage battery in water so that the fire is extinguished. However, there is a problem in that it is not easy to install the prefabricated water tank around the vehicle where the fire occurs.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY OF PRESENT DISCLOSURE

Various aspects of the present disclosure are directed to providing a system and a method for extinguishing a fire in a high voltage battery for a vehicle, which intensively supply cooling water flowing in an upper portion of a high voltage battery for cooling to the high voltage battery when a fire occurs in the high voltage battery, extinguishing the fire using the cooling water.

Other objects and advantages of the present disclosure may be understood by the following description and become apparent with reference to the exemplary embodiments of the present disclosure. Also, it is obvious to those skilled in the art to which the present disclosure pertains that the objects and advantages of the present disclosure may be realized by the means as claimed and combinations thereof.

In accordance with an exemplary embodiment of the present disclosure, there is provided a system for extinguishing a fire in a high voltage battery for a vehicle, which includes a battery cell assembly in which battery cells are stacked, an upper cooling passage which is provided in an upper portion of the battery cell assembly and through which cooling water flows, an upper plate including at least one through-hole and disposed between the battery cell assembly and the upper cooling passage to separate the battery cell assembly and the upper cooling passage, and solderings disposed in the at least one through-hole in the upper plate at intervals and configured to be melted at a predetermined temperature, wherein, in response that a temperature of the battery cell assembly due to the fire is higher than or equal to the predetermined temperature, the solderings are melted and thus the cooling water flowing through the upper cooling passage is supplied to the battery cell assembly.

The solderings may be disposed in the upper plate at intervals.

The system may further include a water pump disposed in a cooling water line connecting the upper cooling passage and a radiator and configured to pressurize and circulate the cooling water: and a controller electrically connected to the water pump and configured to operate the water pump to increase an output of the water pump when the fire occurs in the battery cell assembly.

The controller may operate the water pump at a maximum output thereof when the fire in the battery cell assembly is detected.

The controller may stop the water pump when the controller concludes that a water level of the cooling water reaches a predetermined water level indicating that the battery cell assembly is submerged.

A temperature sensor may be provided to measure a temperature of the battery cell assembly and transmit the measured temperature to the controller, and the controller may be configured to conclude that the fire occurs in the battery cell assembly when the temperature of the battery cell assembly input from the temperature sensor is higher than or equal to a thermal runaway temperature.

In accordance with another exemplary embodiment of the present disclosure, there is provided a method of extinguishing a fire in a high voltage battery for a vehicle, which includes a battery temperature comparison step of determining, by a controller, whether a temperature of a battery cell assembly is higher than or equal to a melting temperature of a soldering: and a water pump start-up operation of operating a water pump located in an upper portion of the battery cell assembly and configured to pressurize and supply cooling water to an upper cooling passage through which the cooling water flows, wherein the cooling water of the upper cooling passage is supplied to the battery cell assembly when the fire occurs in the battery cell assembly.

A fail-safe step may be performed between the battery temperature comparison step and the water pump start-up operation, when the soldering provided to pass through an upper plate separating the battery cell assembly from the upper cooling passage is melted due to a thermal runaway of the battery cell assembly and when the battery cell assembly is submerged in the cooling water and thus a high voltage system controller is in a communication disable state: and the water pump start-up operation may include operating the water pump by a predetermined logic.

The water pump start-up operation may include operating the water pump at a maximum output thereof.

The method may further include a submergence completion determining step of determining whether a water level of the cooling water inside the battery cell assembly is higher than or equal to a predetermined water level indicating that the battery cell assembly is completely submerged: and a water pump stopping step of stopping the operation of the water pump when the water level of the cooling water is higher than or equal to the predetermined water level.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic diagram illustrating a system for extinguishing a fire in a high voltage battery for a vehicle according to an exemplary embodiment of the present disclosure.

FIG. 2 is a schematic diagram illustrating the system for extinguishing a fire in a high voltage battery for a vehicle according to an exemplary embodiment of the present disclosure when a fire occurs in the high voltage battery.

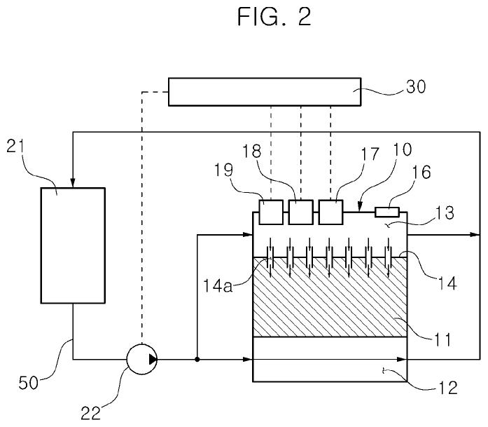

FIG. 3 is a flowchart illustrating a method of extinguishing a fire in a high voltage battery for a vehicle according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a system and a method for extinguishing a fire in a high voltage battery for a vehicle according to an exemplary embodiment of the present disclosure will be described in detail with reference to the accompanying drawings.

The system for extinguishing a fire in a high voltage battery for a vehicle according to an exemplary embodiment of the present disclosure includes a battery cell assembly 11 in which battery cells are stacked, an upper cooling passage 13 which is provided in an upper portion of the battery cell assembly 11 and through which cooling water flows, an upper plate 14 disposed between the battery cell assembly 11 and the upper cooling passage 13, and solderings 15 melted at a predetermined temperature and disposed in the upper plate 14 at intervals to pass through the upper plate 14. When a temperature of the battery cell assembly 11 due to a fire is higher than or equal to a predetermined temperature, the solderings 15 are melted and the cooling water flowing through the upper cooling passage 13 is supplied to the battery cell assembly 11.

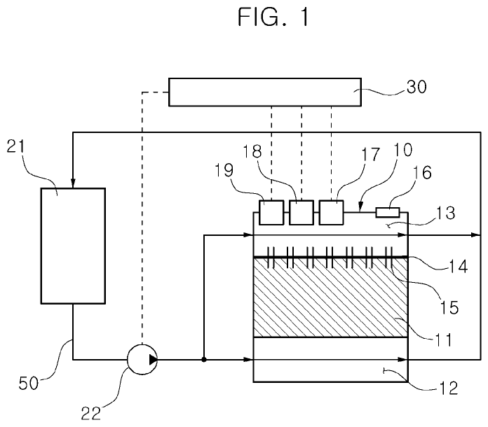

As shown in FIG. 1, in the high voltage battery of the present disclosure, the battery cells are stacked to form the battery cell assembly 11, and the battery cell assembly 11 is packed in cases such as an upper case and a lower case to include a shape of a battery pack 10.

The battery cell assembly 11 is cooled by cooling water to operate at an optimum temperature. In the battery pack 10, the upper cooling passage 13 and a lower cooling passage 12 are respectively formed to allow cooling water to flow through the upper portion and a lower portion of the battery cell assembly 11.

The upper cooling passage 13 and the lower cooling passage 12 are connected to a radiator 21 through a cooling water line 50, and the cooling water circulates the radiator 21 and the upper cooling passage 13 or the lower cooling passage 12, cooling the battery cell assembly 11.

The cooling water line 50 branches off in front of the upper cooling passage 13 and the lower cooling passage 12, passes through each of the upper cooling passage 13 and the lower cooling passage 12, and then joins again to return to the radiator 21.

A water pump 22 for pressurizing and discharging the cooling water is provided at the cooling water line 50, and the water pump 22 operates to circulate the cooling water in a predetermined direction.

In an exemplary embodiment of the present disclosure, when a fire occurs in the battery cell assembly 11, the cooling water circulating for cooling is supplied to inside of the battery cell assembly 11 so that the cooling water extinguishes the fire in the battery cell assembly 11. To the present end, the solderings 15 are disposed to pass through the upper plate 14. The upper plate 14 is provided between the battery cell assembly 11 and the upper cooling passage 13 to spatially separate the battery cell assembly 11 from the upper cooling passage 13.

The solderings 15 are provided in the upper plate 14 at a plurality of points at intervals to pass through the upper plate 14. That is, through-holes 14a are formed in the upper plate 14 at a plurality of points at intervals, and the solderings 15 are provided in a form of closing each of the through-holes 14a.

In an ordinary situation, the soldering 15 is maintained in a state of closing the through-hole 14a.

However, when a fire occurs in the battery cell assembly 11, a temperature of the battery cell assembly 11 increases, and when the temperature becomes higher than a melting temperature of the soldering 15, the soldering 15 is melted by heat due to the fire. Because the soldering 15 includes a melting point which is relatively lower than those of other metals, the soldering 15 is easily melted in the event of fire.

When the soldering 15 is melted, the through-hole 14a where the soldering 15 is positioned is opened and becomes a passage through which the cooling water flows. Thus, the cooling water of the upper cooling passage 13 flows into the battery cell assembly 11.

The cooling water flows into the battery cell assembly 11 in which the fire occurs, so that the fire occurring in the battery cell assembly 11 may be extinguished at an early stage. Because the battery cell assembly 11 is packed in a form of a battery pack 10 in the upper case and the lower case, even when water is sprayed from the outside, the water does not reach the battery cell assembly 11. However, when the cooling water flowing through the upper cooling passage 13 is supplied through the through-hole 14a formed in the upper plate 14, the cooling water may be directly supplied to the battery cell assembly 11.

Thus, the fire may be rapidly extinguished by the cooling water directly supplied to the battery cell assembly 11 in which the fire occurs.

Meanwhile, a main controller 30 may be provided to accelerate an amount and a supply speed of the cooling water supplied to the inside of the battery cell assembly 11 when the fire in the battery cell assembly 11 is detected.

When the fire in the battery cell assembly 11 is detected, the main controller 30 increases an output of the water pump 22, increasing the amount and speed of the cooling water supplied to the battery cell assembly 11. When the fire is detected, the main controller 30 operates the water pump 22 at maximum output, and thus the amount and speed of cooling water supplied to the battery cell assembly 11 through the upper cooling passage 13 is maximized so that the fire in the battery cell assembly 11 may be rapidly extinguished at an early stage.

Furthermore, when a sufficient amount of the cooling water is supplied to the battery cell assembly 11, the main controller 30 stops the operation of the water pump 22 to stop a further supply of the cooling water. When the cooling water is continuously supplied to the inside of the battery cell assembly 11, a pressure inside the battery pack 10 rises and thus there is a possibility of explosion of the battery cell assembly 11. Therefore, when the battery cell assembly 11 is completely submerged by the cooling water, the main controller 30 stops the operation of the water pump 22 to prevent the cooling water from being further supplied.

Meanwhile, a member for detecting that the main controller 30 detects the fire in the battery cell assembly 11 and that the battery cell assembly 11 is completely submerged in the cooling water is provided.

A temperature sensor 17 is provided at one side of the battery pack 10. The temperature sensor 17 measures a temperature of the battery cell assembly 11 and outputs the measured temperature to the main controller 30. When the temperature of the battery cell assembly 11 detected by the temperature sensor 17 is higher than a predetermined thermal runaway temperature for determining that a thermal runaway occurs in the battery cell assembly 11, it may be determined that the fire occurs in the battery cell assembly 11.

Meanwhile, a sensor is provided to determine a water level of the cooling water supplied to the inside of the battery pack 10 when the fire occurs in the battery pack 10.

A sensor configured for determining a water level of the cooling water may be a pressure sensor 18 which is configured for measuring an internal pressure of the battery pack 10 or a water level sensor that directly detects a water level of the cooling water. As a water level of the battery pack 10 increases by the cooling water supplied into the battery pack 10, an internal pressure of the battery pack 10 increases. Therefore, the pressure sensor 18 may indirectly measure the water level of the cooling water through the internal pressure.

A high voltage system controller 19 is provided inside the battery pack 10 or provided adjacent thereto to control a high voltage system including the battery pack 10. While continuously communicating with the main controller 30 of the vehicle, the high voltage system controller 19 transmits a state of the battery cell assembly 11 to the main controller 30, and is configured to control the battery cell assembly 11 according to a command transmitted from the main controller 30. When the soldering 15 is melted and thus the cooling water starts to be supplied to the battery cell assembly 11, a signal output from the high voltage system controller 19 is interrupted due to submergence. When the signal input from the high voltage system controller 19 is interrupted, the main controller 30 operates by a fail-safe logic which is a pre-stored logic. A case in which the high voltage system controller 19 is submerged is a case in which the cooling water is supplied to the battery cell assembly 11 due to a fire, which means that the fire occurs in the battery cell assembly 11.

Accordingly, the main controller 30 operates the water pump 22 to increase an output thereof, rapidly extinguishing the fire in the battery cell assembly 11.

The battery pack 10 is provided with a vapor discharge valve 16 for discharging internal vapor to the outside when the internal pressure of the battery pack 10 increases.

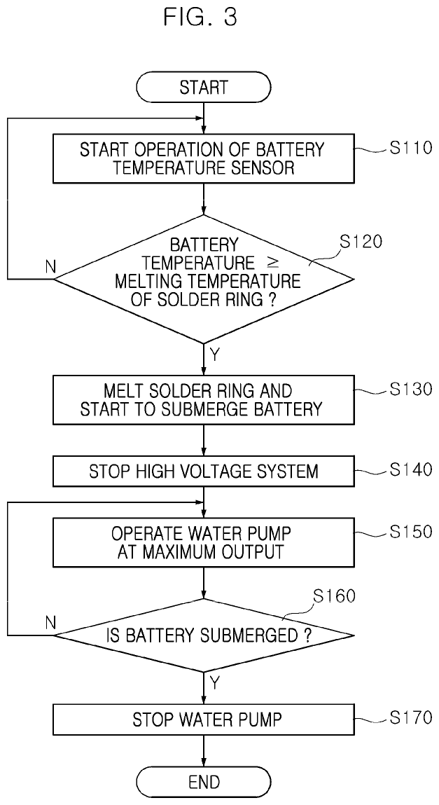

FIG. 3 shows a method of extinguishing a fire in a high voltage battery for a vehicle according to an exemplary embodiment of the present disclosure.

In a sensor operation start-up step S110, a sensor configured for detecting a fire in the battery cell assembly 11 starts to operate and an output value of the sensor starts to be input to the main controller 30. That is, an output value of the temperature sensor 17 which is configured for measuring a temperature of the battery cell assembly 11 is input to the main controller 30. The system for extinguishing a fire in a high voltage battery for a vehicle starts to operate through the sensor operation start-up step S110.

In a battery temperature comparison step S120, the main controller 30 is configured to determine whether a temperature of the battery cell assembly 11 is higher than or equal to a melting temperature of the soldering 15.

In a submergence start-up step S130, when the temperature of the battery cell assembly 11 is higher than or equal to the melting temperature of the soldering 15 in the battery temperature comparison step S120, the soldering 15 is melted. When the soldering 15 is melted, the cooling water flowing through the upper cooling passage 13 flows into the battery cell assembly 11 through the through-hole 14a of the upper plate 14, and the battery cell assembly 11 starts to be submerged.

The upper plate 14 is provided with the soldering 15. Thus, when the fire occurs in the battery cell assembly 11, the soldering 15 is melted regardless of the control of the main controller 30. When the through-hole 14a of the upper plate 14 becomes an opened state due to the melting of the soldering 15, the cooling water flowing through the upper cooling passage 13 directly flows into the battery cell assembly 11 through the through-hole 14a so that the battery cell assembly 11 starts to be submerged.

In a fail-safe step S140, when the battery cell assembly 11 is submerged in the cooling water and thus the high voltage system controller 19 is in a communication disable state, the main controller 30 is configured to perform a predetermined logic.

In a water pump start-up operation S150, when the fire occurs in the battery cell assembly 11, the main controller 30 operates to increase an output to supply a larger amount of the cooling water than usual to the upper cooling passage 13. The main controller 30 operates the water pump 22 at a maximum output thereof to maximize a supply amount and a supply speed of the cooling water to allow the cooling water to be supplied. Because the water pump 22 operates at maximum output, the cooling water is rapidly supplied to the inside of the battery cell assembly 11 so that quick extinguishing is possible.

Meanwhile, when the supply of the cooling water into the battery cell assembly 11 continues, a pressure inside the battery cell assembly 11 increases, and thus the battery cell assembly 11 may explode due to the increased pressure.

To prevent the explosion, it is necessary to supply the cooling water to the battery cell assembly 11 in an amount capable of extinguishing the fire in the battery cell assembly 11 and then block the supply of the cooling water.

In a submergence completion determining step S160, it is determined whether the water level of the cooling water inside the battery cell assembly 11 is higher than or equal to a predetermined water level indicating that the battery cell assembly 11 is completely submerged. In the instant case, the water level of the cooling water may be directly measured or indirectly measured using the pressure sensor 18. That is, the water level may be determined according to whether a pressure inside the battery cell assembly 11 reaches a predetermined pressure using the pressure sensor 18 for monitoring a state of the battery cell assembly 11 without mounting a separate water level sensor. When the pressure inside the battery cell assembly 11 reaches the predetermined pressure so that the battery cell assembly 11 may be completely submerged in the cooling water to maintain a stable state, the main controller 30 may be configured to determine that the battery cell assembly 11 is completely submerged.

A water pump stopping step S170 is performed when it is determined that the battery cell assembly 11 is completely submerged in the cooling water in the submergence completion determining step S160. In the water pump stopping step S170, the main controller 30 stops the water pump 22 which is operating, preventing the cooling water from being further supplied to the battery cell assembly 11.

In accordance with a system and a method for extinguishing a fire in a high voltage battery for a vehicle according to an exemplary embodiment of the present disclosure, which include the above-described configuration, when it is detected that a fire occurs in a high voltage battery, an upper plate fastened to an upper portion of the high voltage battery is melted due to high-temperature heat, and cooling water flowing in the upper portion of the high voltage battery can flow into the high voltage battery so that the cooling water may be supplied at an early stage of the fire to extinguish the fire.

When the fire is detected, a water pump may be operated at a maximum output thereof to intensively supply the cooling water to the high voltage battery so that the fire may be rapidly extinguished.

Furthermore, when a water level of the cooling water reaches a predetermined value and thus the high voltage battery is submerged, the operation of the water pump is stopped to reduce consumption of the cooling water and maintain a completely submerged state of the high voltage battery so that the fire may be prevented from proceeding.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular form may also include a plural form. The expression “at least one (or one or more) of A, B, and C” may include at least one of all combinations which may include combining A, B, and C.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

A singular expression includes a plural expression unless the context clearly indicates otherwise.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A system for extinguishing a fire in a high voltage battery for a vehicle, the system comprising:
a battery cell assembly in which battery cells are stacked;
an upper cooling passage which is provided in an upper portion of the battery cell assembly and through which cooling water flows;
an upper plate including at least one through-hole and disposed between the battery cell assembly and the upper cooling passage to separate the battery cell assembly and the upper cooling passage; and
solderings disposed in the at least one through-hole in the upper plate at intervals and configured to be melted at a predetermined temperature,
wherein, in response that a temperature of the battery cell assembly due to the fire is higher than or equal to the predetermined temperature, the solderings are melted and thus the cooling water flowing through the upper cooling passage is supplied to the battery cell assembly through the at least one through-hole.

2. The system of claim 1, wherein the solderings are disposed in the upper plate at intervals.

3. The system of claim 1, further including:
a water pump disposed in a cooling water line connecting the upper cooling passage and a radiator and configured to pressurize and circulate the cooling water; and
a controller electrically connected to the water pump and configured to operate the water pump to increase an output of the water pump when the fire occurs in the battery cell assembly.

4. The system of claim 3, wherein the water pump is connected to a lower coupling passage coupled to a lower portion of the battery cell assembly and configured to pressurize and circulate the cooling water in the lower coupling passage.

5. The system of claim 3, wherein the controller is further configured to operate the water pump at a maximum output thereof when the fire in the battery cell assembly is detected.

6. The system of claim 3, wherein the controller is further configured to stop the water pump when the controller concludes that a water level of the cooling water reaches a predetermined water level indicating that the battery cell assembly is submerged.

7. The system of claim 3, further including:
a temperature sensor provided to measure a temperature of the battery cell assembly and configured to transmit the measured temperature to the controller,
wherein the controller is further configured to conclude that the fire occurs in the battery cell assembly when the temperature of the battery cell assembly input from the temperature sensor is higher than or equal to a thermal runaway temperature.

8. The system of claim 3, further including:
wherein when the controller concludes that the battery cell assembly is submerged by the cooling water, the controller is configured for stopping operation of the water pump.

9. The system of claim 8, further including:
a sensor configured for determining a water level of the cooling water in the battery cell assembly,
wherein the controller is further configured to conclude that the battery cell assembly is submerged by the cooling water upon concluding that the water lever of the cooling water is more than a predetermined level.

10. The system of claim 9,
wherein the sensor includes a pressure sensor configured for measuring an internal pressure of a battery pack in the battery cell assembly, and
wherein the controller is further configured to conclude that the battery cell assembly is submerged by the cooling water upon concluding that the measured internal pressure of the battery pack is more than a predetermined pressure.

11. The system of claim 8, further including a high voltage system controller electrically connected to the controller and configured to transmit a state of the battery cell assembly to the controller, and to control the battery cell assembly according to a command transmitted from the controller,
wherein the controller is further configured to conclude that the battery cell assembly is submerged by the cooling water, in response that a signal input from the high voltage system controller is interrupted.

12. A method of extinguishing a fire in a high voltage battery for a vehicle, the method comprising:
a battery temperature comparison step of determining, by a controller, whether a temperature of a battery cell assembly is higher than or equal to a melting temperature of a soldering; and
a water pump start-up operation of operating, by the controller, a water pump located in an upper portion of the battery cell assembly to pressurize and supply a cooling water to an upper cooling passage through which the cooling water flows,
wherein the cooling water of the upper cooling passage is supplied to the battery cell assembly when the fire occurs in the battery cell assembly.

13. The method of claim 12,
wherein a fail-safe step is performed between the battery temperature comparison step and the water pump start-up operation, when the soldering provided to pass through an upper plate separating the battery cell assembly from the upper cooling passage is melted due to a thermal runaway of the battery cell assembly and when the battery cell assembly is submerged in the cooling water and thus a high voltage system controller is in a communication disable state with the controller, and
wherein the water pump start-up operation includes operating the water pump by a predetermined logic.

14. The method of claim 12, wherein the water pump start-up operation includes operating the water pump at a maximum output thereof.

15. The method of claim 12, further including:
a submergence completion determining step of determining whether a water level of the cooling water inside the battery cell assembly is higher than or equal to a predetermined water level indicating that the battery cell assembly is completely submerged; and
a water pump stopping step of stopping operation of the water pump when the water level of the cooling water is higher than or equal to the predetermined water level.

16. The method of claim 15, wherein the controller is configured to conclude that the battery cell assembly is submerged by the cooling water upon concluding that an internal pressure of a battery pack in the battery cell assembly is more than a predetermined pressure.

17. The method of claim 15,
wherein the controller is further configured to conclude that the battery cell assembly is submerged by the cooling water, in response that a signal input from a high voltage system controller is interrupted, and
wherein the high voltage system controller is electrically connected to the controller and configured to transmit a state of the battery cell assembly to the controller, and to control the battery cell assembly according to a command transmitted from the controller.

18. The method of claim 12, wherein the controller includes:
a processor; and
a non-transitory storage medium on which a program for performing the method of claim 12 and for being executed by the processor is recorded.
